(19) United States
(12) Patent Application Publication
(10) Pub. No.: US 2013/0037301 A1
(43) Pub. Date: Feb. 14, 2013

(54) Multi-Conductor Stripline RF Transmission Cable

(71) Applicants: Jeffrey D. Paynter, Momence, IL (US); Frank A. Harwath, Naperville, IL (US); Ronald Alan Vaccaro, Shorewood, IL (US); Kendrick Van Swearingen, Woodridge, IL (US); Alan Neal Moe, Hickory, NC (US)

(72) Inventors: Jeffrey D. Paynter, Momence, IL (US); Frank A. Harwath, Naperville, IL (US); Ronald Alan Vaccaro, Shorewood, IL (US); Kendrick Van Swearingen, Woodridge, IL (US); Alan Neal Moe, Hickory, NC (US)

(73) Assignee: ANDREW LLC, Hickory, NC (US)

(21) Appl. No.: 13/570,988

(22) Filed: Aug. 9, 2012

Related U.S. Application Data
(63) Continuation-in-part of application No. 13/427,313, filed on Mar. 22, 2012.
Application No. 13/427,313 is a continuation-in-part of application No. 13/208,443, filed on Aug. 12, 2011.

(51) Int. Cl. H01B 7/02

(52) U.S. Cl. 174/115

(57) ABSTRACT

A stripline RF transmission cable has a plurality of generally planar inner conductors surrounded by a dielectric layer that is surrounded by an outer conductor. The inner conductors may be aligned coplanar, inner conductor edge to inner conductor edge, separated by the dielectric layer. Alternatively, the inner conductors may be provided in a vertical stack. A shield element may be applied between the inner conductors. The shield element may be electrically coupled to the outer conductor to entirely isolate the inner conductors from one another.

### CROSS REFERENCE TO RELATED APPLICATIONS

This application is a continuation-in-part of commonly owned co-pending U.S. Utility Patent Application Ser. No. 13/208,443, titled “Stripline RF Transmission Cable” filed 12 Aug. 2011 by Frank A. Harwath, hereby incorporated by reference in its entirety. This application is also a continuation-in-part of commonly owned co-pending U.S. Utility Patent Application Ser. No. 13/427,313, titled “Low Attenuation Stripline RF Transmission Cable” filed 22 Mar. 2012 by Frank A. Harwath, hereby incorporated by reference in its entirety, which is a continuation-in-part of U.S. Utility Patent Application Ser. No. 13/208,443.

### BACKGROUND

1. Field of the Invention

RF Transmission systems are used to transmit RF signals from point to point, for example, from an antenna to a transceiver or the like. Common forms of RF transmission systems include coaxial cables and striplines.

2. Description of Related Art

Prior coaxial cables typically have a coaxial configuration with a circular outer conductor evenly spaced away from a circular inner conductor by a dielectric support such as polyethylene foam or the like. The electrical properties of the dielectric support and spacing between the inner and outer conductor define a characteristic impedance of the coaxial cable. Circumferential uniformity of the spacing between the inner and outer conductor prevents introduction of impedance discontinuities into the coaxial cable that would otherwise degrade electrical performance.

An industry standard characteristic impedance is 50 ohms. Coaxial cables configured for 50 ohm characteristic impedance generally have an increased inner conductor diameter compared to higher characteristic impedance coaxial cables such that the metal inner conductor material cost is a significant portion of the entire cost of the resulting coaxial cable. To minimize material costs, the inner and outer conductors may be configured as thin metal layers for which structural support is then provided by less expensive materials. For example, commonly owned U.S. Pat. No. 6,800,809, titled “Coaxial Cable and Method of Making Same”, by Moe et al, issued Oct. 5, 2004, hereby incorporated by reference in the entirety, discloses a coaxial cable structure wherein the inner conductor is formed by applying a metallic strip around a cylindrical filler and support structure comprising a cylindrical plastic rod support structure with a foamed dielectric layer therearound. The resulting inner conductor structure has significant materials cost and weight savings compared to coaxial cables utilizing solid metal inner conductors. However, these structures can incur additional manufacturing costs, due to the multiple additional manufacturing steps required to sequentially apply each layer of the structure.

One limitation with respect to metal conductors and/or structural supports replacing solid metal conductors is bend radius. Generally, a larger diameter coaxial cable will have a reduced bend radius before the coaxial cable is distorted and/or buckled by bending. In particular, structures may buckle and/or be displaced out of coaxial alignment by cable bending in excess of the allowed bend radius, resulting in cable collapse and/or degraded electrical performance.

Cables with multiple conductors are known. However, cables suitable for RF signal transmission typically require duplication of the entire shielding structure (an outer conductor coaxially surrounding each inner conductor) to prevent cross talk between adjacent RF signal conductors, reducing the potential for materials savings in a multiple conductor RF signal cable.

A stripline is a flat conductor sandwiched between parallel interconnected ground planes. Striplines have the advantage of being non-dispersive and may be utilized for transmitting high frequency RF signals. Striplines may be cost effectively generated using printed circuit board technology or the like. However, striplines may be expensive to manufacture in longer lengths/larger dimensions. Further, where a solid stacked printed circuit board type stripline structure is not utilized, the conductor sandwich is generally not self supporting and/or aligning, compared to a coaxial cable, and as such may require significant additional support/reinforcing structure.

Competition within the RF cable industry has focused attention upon reducing materials and manufacturing costs, electrical characteristic uniformity, defect reduction and overall improved manufacturing quality control.

Therefore, it is an object of the invention to provide a coaxial cable and method of manufacture that overcomes deficiencies in such prior art.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a schematic isometric view of an exemplary cable, with layers of the conductors, dielectric spacer and outer jacket stripped back.

FIG. 2 is a schematic end view of the cable of FIG. 1.

FIG. 3 is a schematic isometric view demonstrating a bend radius of the cable of FIG. 1.

FIG. 4 is a schematic isometric view of an alternative cable, with layers of the conductors, dielectric spacer and outer jacket stripped back.

FIG. 5 is a schematic end view of an alternative embodiment cable utilizing varied dielectric layer dielectric constant distribution.

FIG. 6 is a schematic end view of another alternative embodiment cable utilizing varied dielectric layer dielectric constant distribution.

FIG. 7 is a schematic end view of an alternative embodiment cable utilizing cavities for varied dielectric layer dielectric constant distribution.

FIG. 8 is a schematic end view of an alternative embodiment cable utilizing sequential vertical layers of varied dielectric constant in the dielectric layer.

FIG. 9 is a schematic end view of an alternative embodiment cable utilizing dielectric rods for varied dielectric layer dielectric constant distribution.

FIG. 10 is a schematic end view of an alternative embodiment cable utilizing dielectric rods for varied dielectric layer dielectric constant distribution.

FIG. 11 is a schematic end view of an alternative embodiment cable utilizing varied outer conductor spacing to modify operating current distribution within the cable.

FIG. 12 is a schematic end view of another alternative embodiment cable utilizing drain wires for varied outer conductor spacing to modify operating current distribution within the cable.

FIG. 13 is a schematic isometric view of another alternative embodiment cable including a plurality of inner conductors aligned coplanar with one another.

FIG. 14 is a schematic end view of the cable of FIG. 13.

FIG. 15 is a schematic end view of an embodiment of the cable of FIG. 13, including a shield element.

FIG. 16 is a schematic isometric view of another alternative embodiment cable including a plurality of inner conductors aligned coplanar with one another, featuring an hourglass outer conductor cross section.

FIG. 17 is a schematic end view of the cable of FIG. 15.

FIG. 18 is a schematic end view of another alternative embodiment cable including a plurality of inner conductors aligned parallel to one another in a vertical stack.

FIG. 19 is a schematic end view of an embodiment of the cable of FIG. 18, including a shield element.

### DETAILED DESCRIPTION

The inventors have recognized that the prior accepted coaxial cable design paradigm of concentric circular cross-section design geometries results in unnecessarily large coaxial cables with reduced bend radius, excess metal material costs and/or significant additional manufacturing process requirements.

The inventors have further recognized that the propagation modes of RF signals along a stripline rather than traditional coaxial conductor structure enables application of multiple stripline conductors enclosed within a common outer conductor, with reduced cross talk compared to multiple circular cross section conductors similarly positioned within an outer conductor.

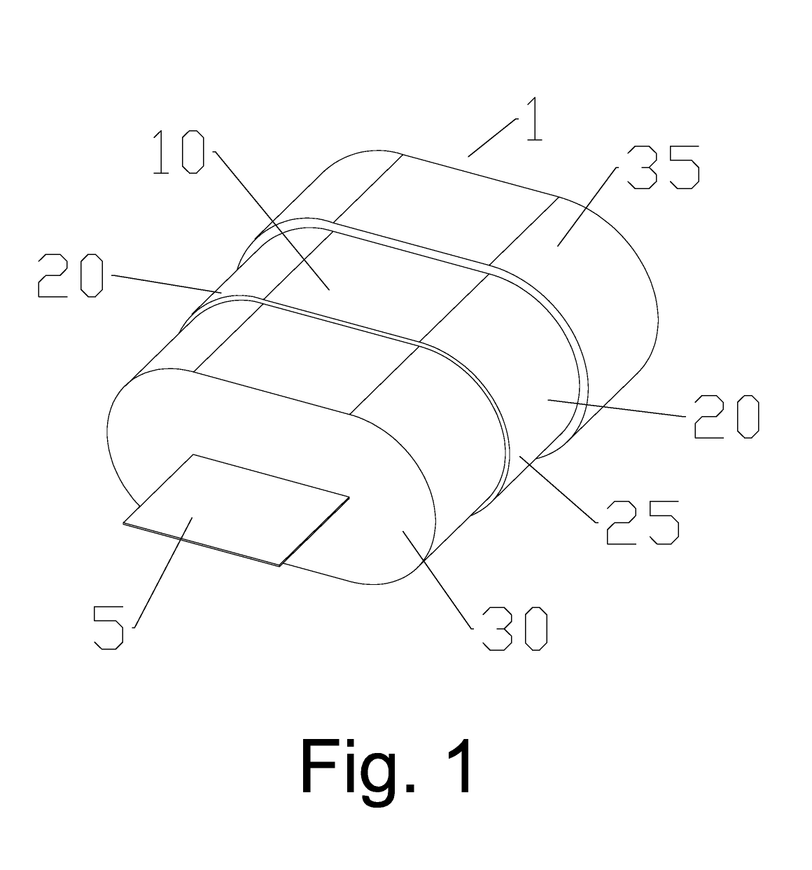

An exemplary stripline RF transmission cable 1 is demonstrated in FIGS. 1-3. As best shown in FIG. 1, the inner conductor 5 of the cable 1, extending generally linear between a pair of inner conductor edges 3, is a generally planar metallic strip, with respect to a longitudinal axis of the cable 1. A top section 10 and a bottom section 15 of the outer conductor 25 are aligned parallel to the inner conductor 5 with widths equal to the inner conductor width. The top and bottom sections 10, 15 transition at each side into convex edge sections 20. Thus, the circumference of the inner conductor 5 is entirely sealed within an outer conductor 25 comprising the top section 10, bottom section 15 and edge sections 20.

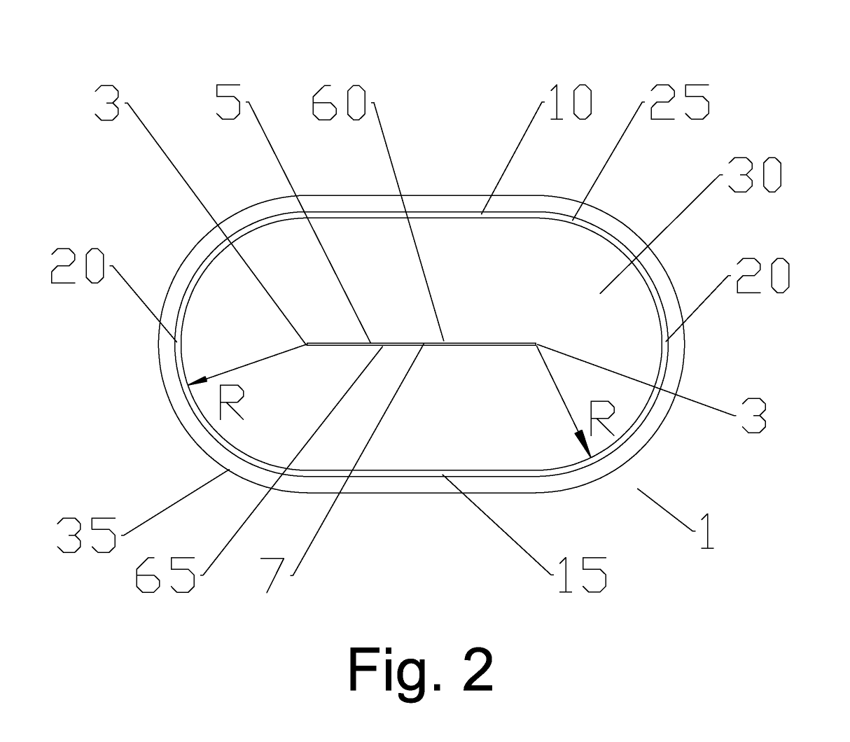

The dimensions/curvature of the edge sections 20 may be selected, for example, for ease of manufacture. Preferably, the edge sections 20 and any transition thereto from the top and bottom sections 10, 15 is generally smooth, without sharp angles or edges. As best shown in FIG. 2, the edge sections 20 may be provided as circular arcs with an arc radius R, with respect to each side of the inner conductor 5, equivalent to the spacing between each of the top and bottom sections 10, 15 and the inner conductor 5, resulting in a generally equal spacing between any point on the circumference of the inner conductor 5 and the nearest point of the outer conductor 25, minimizing outer conductor material requirements.

The desired spacing between the inner conductor 5 and the outer conductor 25 may be obtained with high levels of precision via application of a uniformly dimensioned spacer structure with dielectric properties, referred to as the dielectric layer 30, and then surrounding the dielectric layer 30 with the outer conductor 25. Thereby, the cable 1 may be provided in essentially unlimited continuous lengths with a uniform cross-section at any point along the cable 1.

The inner conductor 5 metallic strip may be formed as solid rolled metal material such as copper, aluminum, steel or the like. For additional strength and/or cost efficiency, the inner conductor 5 may be provided as copper-coated aluminum or copper-coated steel.

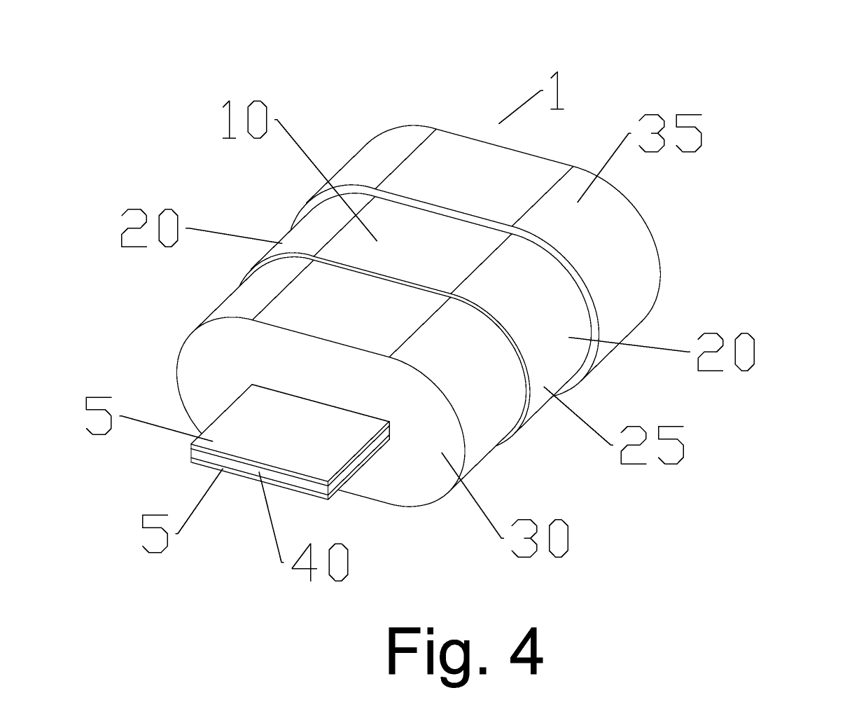

Alternatively, the inner conductor 5 may be provided as a substrate 40 such as a polymer and/or fiber strip that is metal coated or metalized, for example as shown in FIG. 4. One skilled in the art will appreciate that such alternative inner conductor configurations may enable further metal material reductions and/or an enhanced strength characteristic enabling a corresponding reduction of the outer conductor strength characteristics.

The dielectric layer 30 may be applied as a continuous wall of plastic dielectric material around the outer surface of the inner conductor 5. The dielectric layer 30 may be a low loss dielectric material comprising a suitable plastic such as polyethylene, polypropylene, and/or polystyrene. The dielectric material may be of an expanded cellular foam composition, and in particular, a closed cell foam composition for resistance to moisture transmission. Any cells of the cellular foam composition may be uniform in size. One suitable foam dielectric material is an expanded high density polyethylene polymer as disclosed in commonly owned U.S. Pat. No. 4,104,481, titled “Coaxial Cable with Improved Properties and Process of Making Same” by Wilkenloh et al, issued Aug. 1, 1978, hereby incorporated by reference in the entirety. Additionally, expanded blends of high and low density polyethylene may be applied as the foam dielectric.

Although the dielectric layer 30 generally consists of a uniform layer of foam material, as described in greater detail herein below, the dielectric layer 30 can have a gradient or graduated density varied across the dielectric layer cross-section such that the density of the dielectric increases and/or decreases radially from the inner conductor 5 to the outer diameter of the dielectric layer 30, either in a continuous or a step-wise fashion. Alternatively, the dielectric layer 30 may be applied in a sandwich configuration as two or more separate layers together forming the entirety of the dielectric layer 30 surrounding the inner conductor 5.

The dielectric layer 30 may be bonded to the inner conductor 5 by a thin layer of adhesive. Additionally, a thin solid polymer layer and another thin adhesive layer may be present, protecting the outer surface of the inner conductor 5 (for example, as it is collected on reels during cable manufacture processing).

The outer conductor 25 is electrically continuous, entirely surrounding the circumference of the dielectric layer 30 to eliminate radiation and/or entry of interfering electrical signals. The outer conductor 25 may be a solid material such as aluminum or copper material sealed around the dielectric layer as a contiguous portion by seam welding or the like. Alternatively, helically wrapped and/or overlapping folded configurations utilizing, for example, metal foil and/or braided type outer conductor 25 may also be utilized.

If desired, a protective jacket 35 of polymer materials such as polyethylene, polyvinyl chloride, polyurethane and/or rubbers may be applied to the outer diameter of the outer conductor. The jacket 35 may comprise laminated multiple jacket layers to improve toughness, strippability, burn resistance, the reduction of smoke generation, ultraviolet and weatherability resistance, protection against rodent gnaw-through, strength resistance, chemical resistance and/or cut-through resistance.

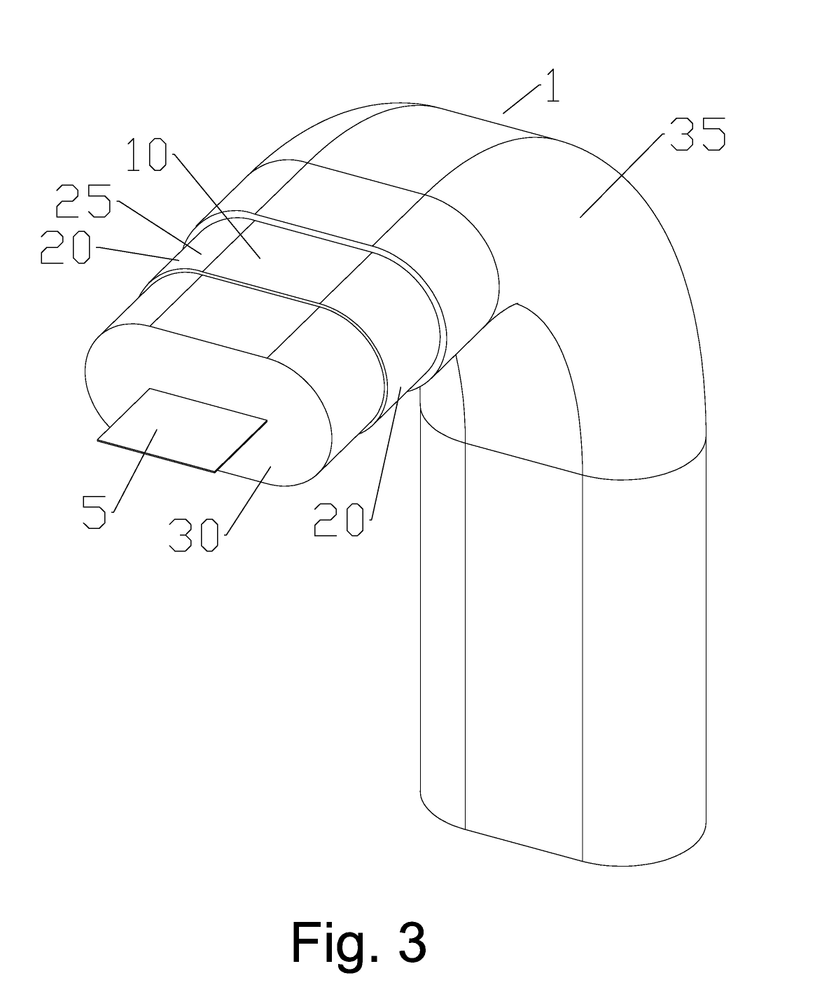

The flattened characteristic of the cable 1 has inherent bend radius advantages. As best shown in FIG. 3, the bend radius of the cable perpendicular to the horizontal plane of the inner conductor 5 is reduced compared to a conventional coaxial cable of equivalent materials dimensioned for the same characteristic impedance. Since the cable thickness between the top section 10 and the bottom section 15 is thinner than the diameter of a comparable coaxial cable, distortion or buckling of the outer conductor 25 is less likely at a given bend radius. A tighter bend radius also improves warehousing and transport aspects of the cable 1, as the cable 1 may be packaged more efficiently, for example provided coiled upon smaller diameter spool cores which require less overall space.

Electrical modeling of stripline-type RF cable structures with top and bottom sections with a width similar to that of the inner conductor (as shown in FIGS. 1-4) demonstrates that the electric field generated by transmission of an RF signal along the cable 1 and the corresponding current density with respect to a cross-section of the cable 1 is greater along the inner conductor edges 3 at either side of the inner conductor 5 than at a mid-section 7 of the inner conductor. Uneven current density generates higher resistivity and increased signal loss. Therefore, the cable configuration may have an increased attenuation characteristic, compared to conventional circular/coaxial type RF cable structures where the inner conductor circumferences are equal.

To obtain the materials and structural benefits of the stripline RF transmission cable 1 as described herein, the electric field strength and corresponding current density may be balanced by increasing the current density proximate the mid-section 7 of the inner conductor 5. The current density may be balanced, for example, by modifying the dielectric constant of the dielectric layer 30 to provide an average dielectric constant that is lower between the inner conductor edges 3 and the respective adjacent edge sections 20 than between a mid-section 7 of the inner conductor 5 and the top and the bottom sections 10,15. Thereby, the resulting current density may be adjusted to be more evenly distributed across the cable cross-section to reduce attenuation.

The dielectric layer 30 may be formed with layers of, for example, expanded open and/or closed-cell foam dielectric material, where the different layers of the dielectric material have a varied dielectric constant. The differential between dielectric constants and the amount of space within the dielectric layer 30 allocated to each type of material may be utilized to obtain the desired average dielectric constant of the dielectric layer 30 in each region of the cross-section of the cable 1.

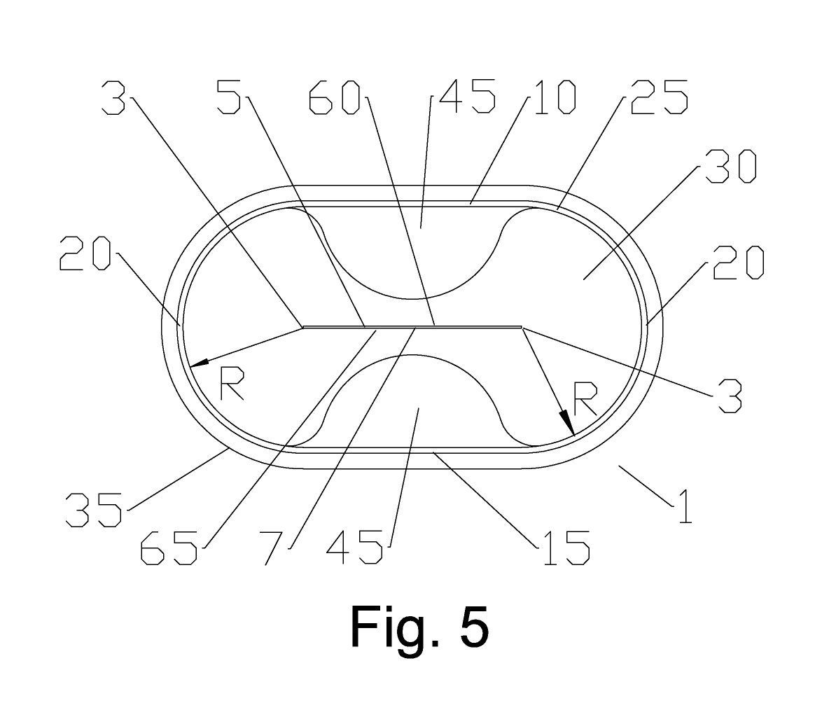

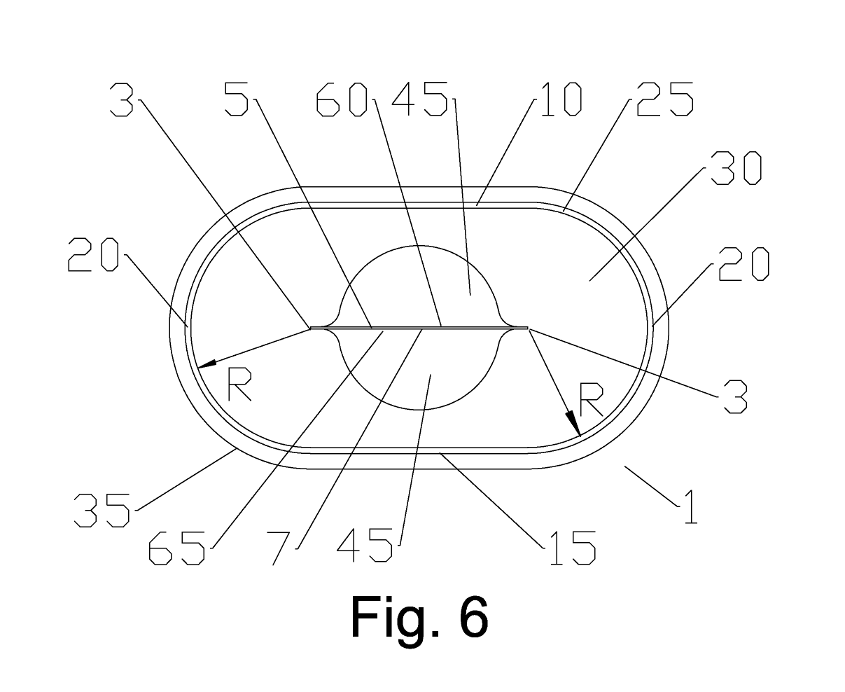

As shown for example in FIG. 5, a dome-shaped increased dielectric constant portion 45 of the dielectric layer 30 may be applied proximate the top section 10 and the bottom section 15 extending inward toward the mid-section 7 of the inner conductor 5. Alternatively, the dome-shaped increased dielectric constant portion 45 of the dielectric layer 30 proximate the inner conductor 5 may be positioned extending outward from the mid-section 7 of the inner conductor 5 towards the top and bottom sections 10,15, as shown for example in FIG. 6.

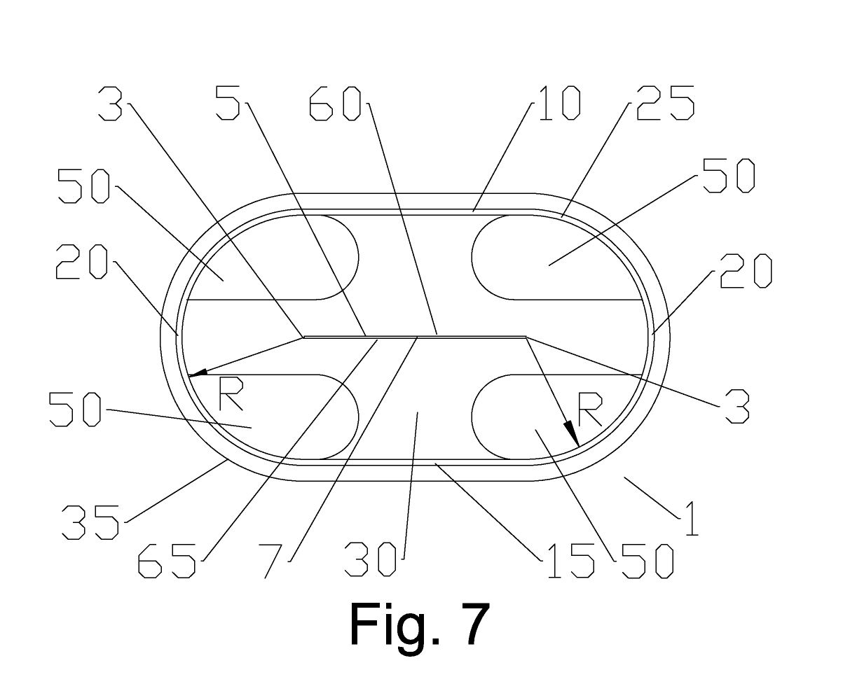

Air may be utilized as a low cost dielectric material. As shown for example in FIG. 7, one or more areas of the dielectric layer 30 proximate the edge sections 20 may be applied as a cavity 50 extending along a longitudinal axis of the cable 1. Such cavities 50 may be modeled as air (pressurized or unpressurized) with a dielectric constant of approximately 1 and the remainder of the adjacent dielectric material of the dielectric layer 30 again selected and spaced accordingly to provide the desired dielectric constant distribution across the cross-section of the dielectric layer 30 when averaged with the cavity portions allocated to air dielectric.

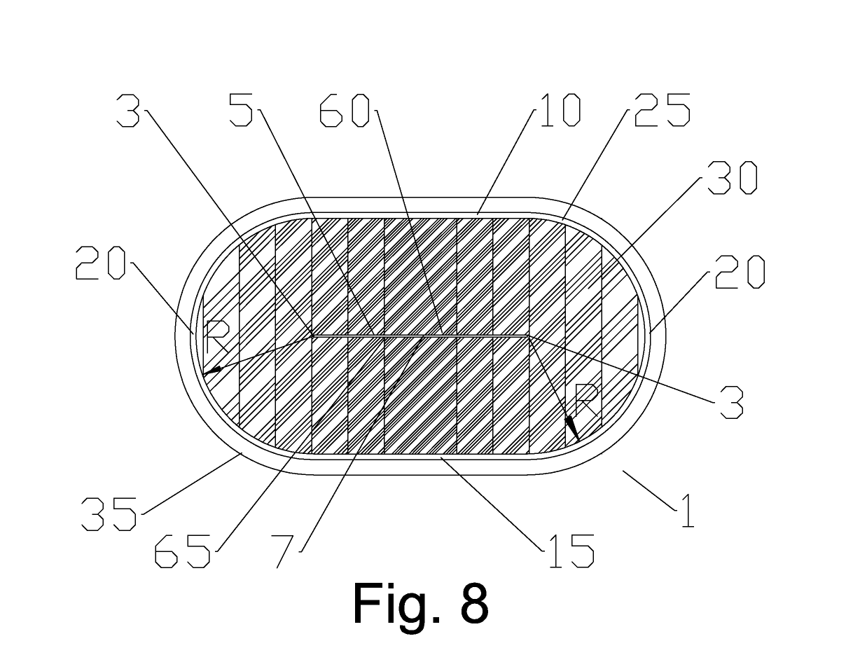

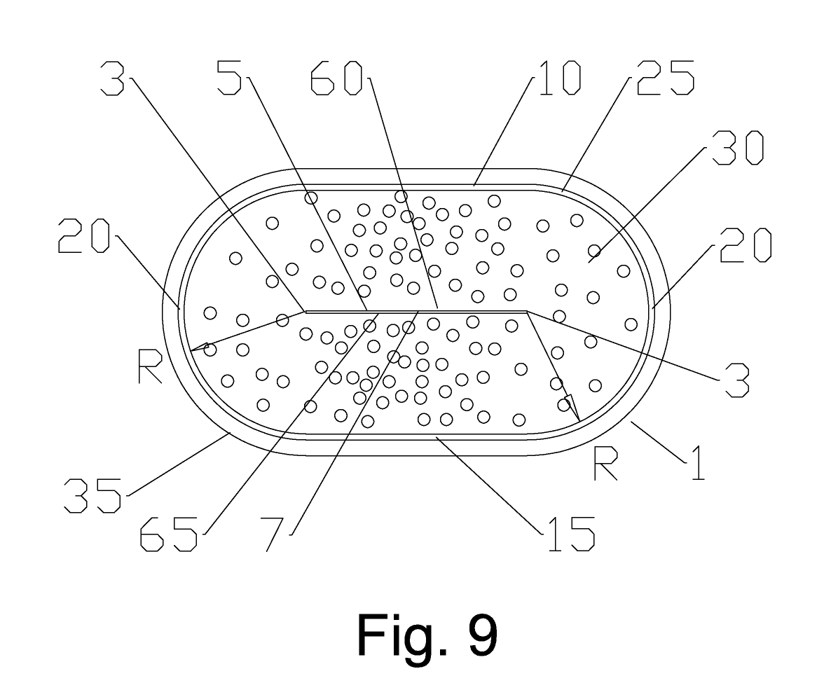

As shown for example in FIG. 8, multiple layers of dielectric material may be applied, for example, as a plurality of vertical layers aligned normal to the horizontal plane of the inner conductor 5, a dielectric constant of each of the vertical layers provided so that the resulting overall dielectric layer dielectric constant increases towards the mid-section 7 of the inner conductor 5 to provide the desired aggregate dielectric constant distribution across the cross-section of the dielectric layer 30. Alternatively, for example as shown in FIG. 9, the dielectric material may be applied as simultaneous high and low (relative to one another) dielectric constant dielectric material streams through multiple nozzles with the proportions controlled with respect to cross-section position by the nozzle distribution or the like so that a position varied mixed stream of dielectric material is applied to obtain a desired (e.g., generally smooth) gradient of the dielectric constant across the cable cross-section, so that the resulting overall dielectric constant of the dielectric layer 30 increases in a generally smooth gradient from the edge sections 20 towards the mid-section 7 of the inner conductor 5.

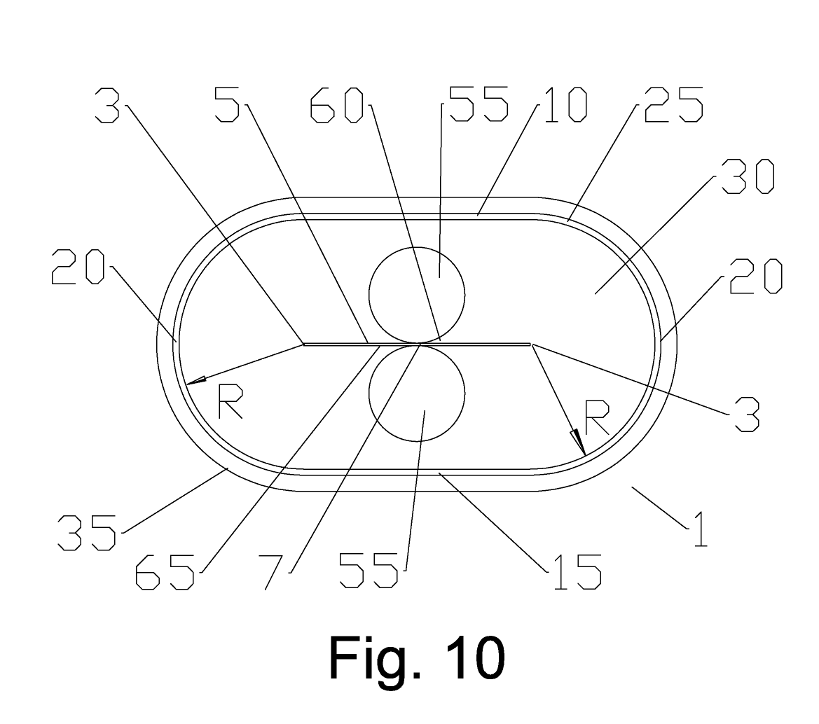

The materials selected for the dielectric layer 30, in addition to providing varying dielectric constants for tuning the dielectric layer cross-section dielectric profile for attenuation reduction, may also be selected to enhance structural characteristics of the resulting cable 1. For example, as shown in FIG. 10, the dielectric layer 30 may be provided with first and second dielectric rods 55 located proximate a top side 60 and a bottom side 65 of the mid-section 7 of the inner conductor 5. The dielectric rods 55, in addition to having a dielectric constant greater than the surrounding dielectric material, may be for example fiberglass or other high strength dielectric materials that improve the strength characteristics of the resulting cable 1. Thereby, the thickness of the inner conductor 5 and/or outer conductor 25 may be reduced to obtain overall materials cost reductions without compromising strength characteristics of the resulting cable 1.

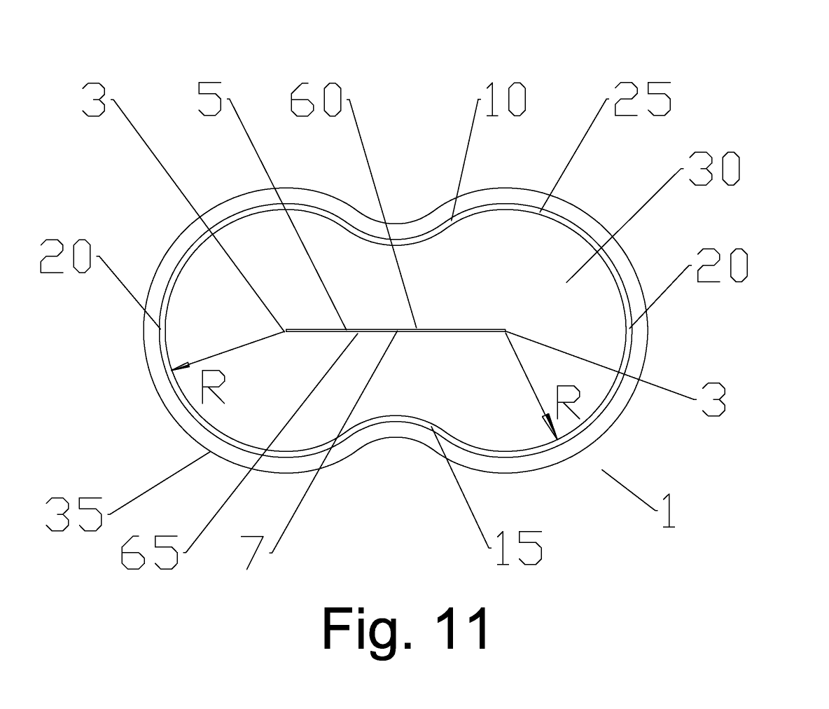

Alternatively and/or additionally, the electric field strength and corresponding current density may also be balanced by adjusting the distance between the outer conductor 25 and the mid-section 7 of the inner conductor 5. For example, as shown in FIG. 11, the outer conductor 25 may be provided spaced farther away from each inner conductor edge 3 than from the mid-section 7 of the inner conductor 5, creating a generally hour glass-shaped cross-section. The distance between the outer conductor 25 and the mid-section 7 of the inner conductor 5 may be less than, for example, 0.7 of a distance between the inner conductor edges 3 and the outer conductor 25 (at the edge sections 20).

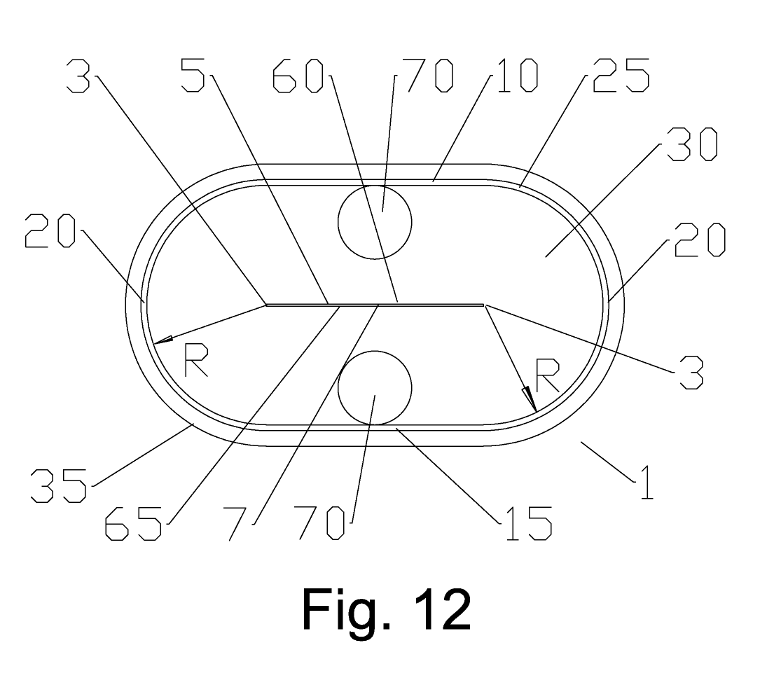

The dimensions may also be modified, for example as shown in FIG. 12, by applying a drainwire 70 coupled to the inner diameter of the outer conductor 25, one proximate either side of the mid-section 7 of the inner conductor 5. Because each of the drain wires 70 is electrically coupled to the adjacent inner diameter of the outer conductor 25, each drain wire 70 becomes an inwardly projecting extension of the inner diameter of the outer conductor 25, again forming the generally hour glass cross-section to average the resulting current density for attenuation reduction. As described with respect to the dielectric rods 55 of FIG. 10, the drain wires 70 may similarly increase structural characteristics of the resulting cable, enabling cost saving reduction of the metal thicknesses applied to the inner conductor 5 and/or outer conductor 25.

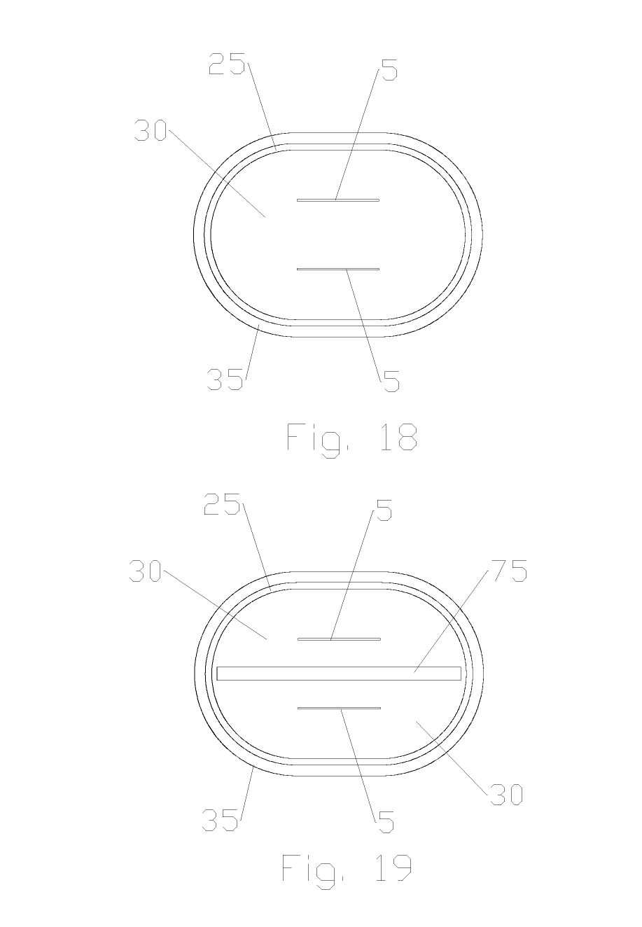

In further embodiments, multiple inner conductors 5 may be provided within a single surrounding outer conductor 25. The inner conductors 5 may be spaced apart from one another within the dielectric layer 30, aligned, inner conductor edge 3 to inner conductor edge 3, generally coplanar with one another, for example as shown in FIGS. 13-17, each of the inner conductors 5 separated from the adjacent inner conductor 5 by the dielectric layer 30. Alternatively, the inner conductors 5 may be provided aligned, inner conductor edge 3 to inner conductor edge 3, generally parallel to one another, with respect to a horizontal plane between the inner conductor edges 3 of each inner conductor 5 and disposed in a vertical stack, for example as shown in FIGS. 18 and 19.

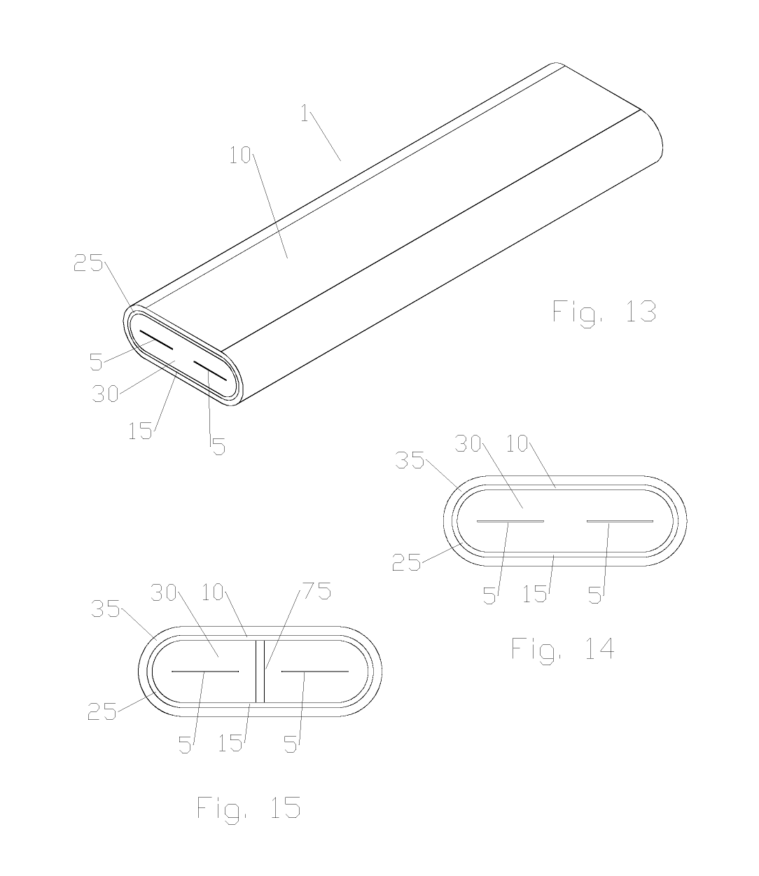

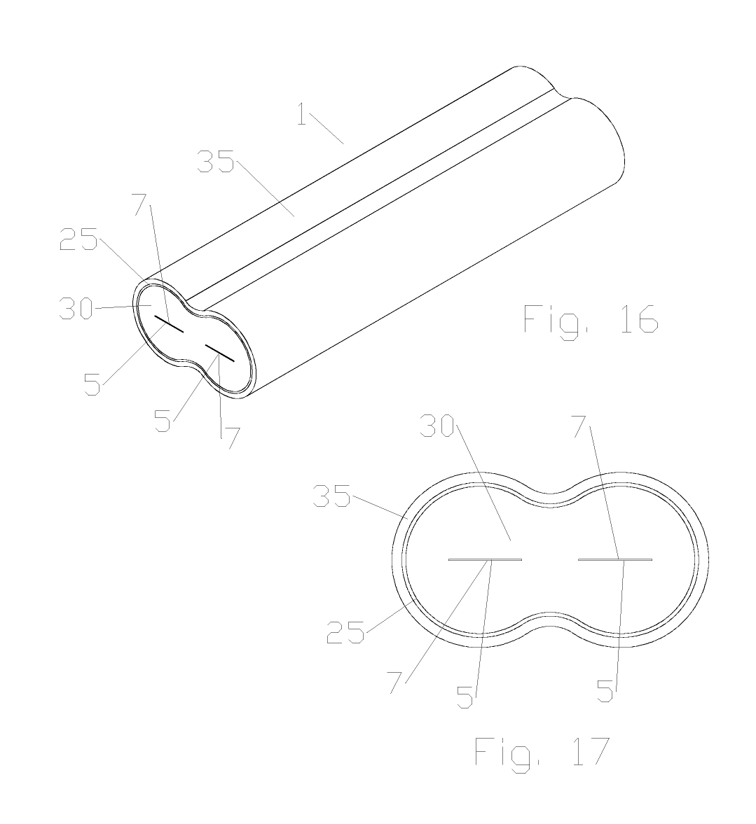

The outer conductor 25 may be provided as a stretched oval cross section with extended width flat top and bottom sections 10, 15, as shown for example in FIGS. 13-15. Alternatively, the outer conductor 25 may be provided with an hourglass cross section wherein the outer conductor 25 is provided spaced farther away from a mid-section 7 of each inner conductor 5 than from each inner conductor edge, for example as shown in FIGS. 16 and 17.

To reduce a chance for cross talk between RF signals transmitted simultaneously along the inner conductors 5, a shield element 75 may be applied, for example as shown in FIGS. 14 and 19. The shield element 75 may be formed as a metallic strip or other RF reflective surface, such as a metal coated or metal mesh element, with any pores of the material and/or fit of the shield element 75 within the outer conductor 25 dimensioned small enough to inhibit passage of the desired RF signal operating bands/frequencies for which the cable 1 is configured.

The shield element 75 may be aligned normal to a horizontal plane defined by an inner conductor edge 3 to inner conductor edge 3 of the inner conductors 5, extending between the top and the bottom sections 10, 15, for example as shown in FIG. 14. An electrical coupling may be applied between the shield element 75 and the top and bottom sections 10, 15 to entirely seal signal paths of each inner conductor 5 from one another. Alternatively, where the inner conductors 5 are applied in a vertical stack, the shield element 75 may be applied parallel to the inner conductors 5, for example as shown in FIG. 19. Here again, the shield element 75 may be electrically coupled to at least one sidewall of the outer conductor 25.

The several FIGS. 13-19 are schematic only. Spacing of the inner conductors 5 from the outer conductor 25, shield element 75 (if present) and/or each other may be varied according to a desired characteristic impedance of each inner conductor 5. Thereby, the cable 1 may be provided, for example, with inner conductors 5 with the same or different characteristic impedances, within the same cable 1. Further, the embodiments are demonstrated with only two inner conductors 5 for clarity. One skilled in the art will appreciate that the plurality of inner conductors 5 may exceed two by extending a width and/or height of the cable 1.

One skilled in the art will appreciate that the cable 1 has numerous advantages over a conventional circular cross-section coaxial cable. Because the desired inner conductor surface area is obtained without applying a solid or hollow tubular inner conductor, a metal material reduction of one half or more may be obtained. Alternatively, because complex inner conductor structures which attempt to substitute the solid cylindrical inner conductor with a metal coated inner conductor structure are eliminated, required manufacturing process steps may be reduced. The several embodiments may each be further configured with multiple inner conductors 5 positioned with the outer conductor 25 to reduce the total number of cables required in an RF transmission system. Thereby, the materials and/or installation costs may be reduced.

Table of Parts

| | |
|---|---|
| 1 | cable |
| 3 | inner conductor edge |
| 5 | inner conductor |
| 7 | mid-section |
| 10 | top section |
| 15 | bottom section |
| 20 | edge section |
| 25 | outer conductor |
| 30 | dielectric layer |
| 35 | jacket |
| 40 | substrate |
| 45 | increased dielectric constant portion |
| 50 | cavity |
| 55 | dielectric rod |
| 60 | top side |
| 65 | bottom side |
| 70 | drain wire |
| 75 | shield element |

Where in the foregoing description reference has been made to ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. A stripline RF transmission cable, comprising:
a plurality of generally planar inner conductors, each of the inner conductors extending between a pair of inner conductor edges;
the inner conductors surrounded by a dielectric layer; and
an outer conductor surrounding the dielectric layer;
the outer conductor provided with a flat top section and a flat bottom section; the top section and the bottom section transitioning to a pair of edge sections which interconnect the top section with the bottom section;
the plurality of inner conductors spaced apart from one another within the dielectric layer, aligned generally coplanar with one another.

2. The cable of claim 1, wherein the inner conductors are aligned inner conductor edge to inner conductor edge, separated by the dielectric layer.

3. The cable of claim 1, further including a shield element between each of the inner conductors.

4. The cable of claim 3, wherein the shield element extends between the top section and the bottom section.

5. The cable of claim 3, wherein the shield element is aligned normal to the inner conductors.

6. The cable of claim 3, wherein the shield element is electrically coupled to the top section and the bottom section.

7. The cable of claim 1, further including a polymer jacket surrounding the outer conductor.

8. A stripline RF transmission cable, comprising:
a plurality of generally planar inner conductors, each of the inner conductors extending between a pair of inner conductor edges;
the inner conductors surrounded by a dielectric layer; and
an outer conductor surrounding the dielectric layer;
the outer conductor provided spaced farther away from a midsection of each inner conductor than from each inner conductor edge.

9. The cable of claim 8, wherein the inner conductors are aligned inner conductor edge to inner conductor edge, separated by the dielectric layer.

10. The cable of claim 8, further including a shield element positioned between each of the inner conductors.

11. The cable of claim 10, wherein the shield element extends between the top section and the bottom section.

12. The cable of claim 10, wherein the shield element is planar, aligned normal to the inner conductors.

13. The cable of claim 10, wherein the shield element is electrically coupled to the outer conductor.

14. The cable of claim 9, further including a polymer jacket surrounding the outer conductor.

15. A stripline RF transmission cable, comprising:
a plurality of generally planar inner conductors, each of the inner conductors extending between a pair of inner conductor edges;
the inner conductors surrounded by a dielectric layer; and
an outer conductor surrounding the dielectric layer;
the inner conductors provided generally parallel to one another, spaced away from one another by the dielectric layer.

16. The cable of claim 13, wherein a horizontal plane between the inner conductor edges of each inner conductor is disposed vertically from one another.

17. The cable of claim 13, further including a shield element between each of the inner conductors.

18. The cable of claim 17, wherein the shield element is provided parallel to a plane defined by the inner conductor edges of each of the inner conductors.

19. The cable of claim 17, wherein the shield element is electrically coupled to a sidewall of the outer conductor.

20. The cable of claim 15, further including a polymer jacket surrounding the outer conductor.
